(19) United States
(12) Patent Application Publication
(10) Pub. No.: US 2026/0280189 A1
(43) Pub. Date: Sep. 17, 2026

(54) FLOATING CONNECTOR TERMINAL

(71) Applicant: Shenzhen Netsok Technology Co.,Ltd, Shenzhen (CN)

(72) Inventors: Quan Ni, Shenzhen (CN); Gongjie Xu, Shenzhen (CN); Dong Zeng, Wuzhou (CN)

(21) Appl. No.: 19/674,277

(22) Filed: May 12, 2026

(30) Foreign Application Priority Data
Jun. 25, 2025 (CN) 202510856905.7

(51) Int. Cl. H01R 13/631; H01R 13/24; H01R 13/506

(52) U.S. Cl. CPC H01R 13/6315; H01R 13/2492; H01R 13/506

(57) ABSTRACT

A floating connector terminal is disclosed, including a carrying member, a floating member, and a first conductive member. The carrying member has a first receiving groove. The first conductive member has a second receiving groove. The first conductive member is located within the first receiving groove. The floating member is located within the second receiving groove. The first conductive member abuts against both the carrying member and the floating member. The floating member can drive the first conductive member to move within the first receiving groove. The second receiving groove of the first conductive member wraps around the floating member, which increases a contact area between the first conductive member and the floating member, improving current-carrying capacity and charging efficiency.

### CROSS-REFERENCE TO RELATED APPLICATIONS

This application claims priority to Chinese Patent Application No. 202510856905.7, filed on June 25, 2025, which is hereby incorporated by reference in its entirety.

### TECHNICAL FIELD

The present disclosure relates to the technical field of connectors, and in particular, to a floating connector terminal.

### BACKGROUND

Based on the characteristic of being movable within a certain range, floating connector terminals are widely used in numerous scenarios. A connector terminal is a key component for realizing current conduction between different components, and its performance directly affects the current conduction effect. At present, common connector terminals have a problem in which charging efficiency is affected due to insufficient current-carrying capacity.

### SUMMARY

In view of the deficiencies of the prior art, the present disclosure provides a floating connector terminal.

A floating connector terminal disclosed by the present disclosure includes: a carrying member, a floating member, and a first conductive member. The carrying member has a first receiving groove. The first conductive member has a second receiving groove. The first conductive member is located within the first receiving groove. The floating member is located within the second receiving groove. The first conductive member abuts against both the carrying member and the floating member. The floating member is capable of driving the first conductive member to move together within the first receiving groove.

According to one embodiment of the present disclosure, the first conductive member includes a support ring, a plurality of first elastic pieces, and a plurality of second elastic pieces. The plurality of first elastic pieces are spaced apart along one end of the support ring. The plurality of second elastic pieces are spaced apart along the other end of the support ring. The support ring, the plurality of first elastic pieces, and the plurality of second elastic pieces jointly form the second receiving groove. The support ring, the plurality of first elastic pieces, and the plurality of second elastic pieces all abut against the floating member. The plurality of first elastic pieces and the plurality of second elastic pieces further abut against side walls of the first receiving groove.

According to one embodiment of the present disclosure, one end portion of the first elastic piece that is closer to the support ring is provided with a first arc surface. The first arc surface abuts against the side wall of the first receiving groove.

According to one embodiment of the present disclosure, one end portion of the first elastic piece that is away from the support ring is provided with a second arc surface. The second arc surface and the first arc surface face in opposite directions. The second arc surface abuts against the floating member.

According to one embodiment of the present disclosure, one end portion of the second elastic piece that is closer to the support ring is provided with a third arc surface. The third arc surface abuts against the side wall of the first receiving groove.

According to one embodiment of the present disclosure, one end portion of the second elastic piece that is away from the support ring is provided with a fourth arc surface. The fourth arc surface and the third arc surface face in opposite directions. The fourth arc surface abuts against the floating member.

According to one embodiment of the present disclosure, the first conductive member may be an integral structure, or a split structure divided along an axial direction, or a split structure divided along a radial direction.

According to one embodiment of the present disclosure, the floating member includes a connecting body and a movable body. The connecting body is movably disposed within a first through hole of the carrying member. The movable body is disposed on an outer periphery of the connecting body, and the movable body is located within the second receiving groove. The movable body drives the first conductive member to move together within the first receiving groove.

According to one embodiment of the present disclosure, the floating connector terminal further includes a second conductive member. The connecting body is provided with a second through hole formed along an axial direction. The second conductive member is disposed within the second through hole.

According to one embodiment of the present disclosure, the floating connector terminal further includes a fixing member located at one end of the connecting body. The fixing member is snap-fit connected with the second conductive member and the connecting body.

Beneficial effects of the present disclosure are as follows. The second receiving groove of the first conductive member wraps around the floating member, which increases a contact area between the first conductive member and the floating member. When in use, a larger current can flow between the carrying member and the floating member, thereby improving the current-carrying capacity and charging efficiency thereof.

### BRIEF DESCRIPTION OF THE DRAWINGS

The drawings illustrated here are used to provide a further understanding of the present disclosure and constitute a part of the present disclosure. The schematic examples of the present disclosure and the descriptions thereof are used to explain the present disclosure and do not constitute an improper limitation to the present disclosure. In the drawings:

FIG. 1 is a schematic perspective structural view of a floating connector terminal;

FIG. 2 is an exploded view of the floating connector terminal;

FIG. 3 is a schematic sectional view of the floating connector terminal;

FIG. 4 is a schematic perspective structural view of a first conductive member;

FIG. 5 is another schematic perspective structural view of the first conductive member;

FIG. 6 is an exploded view of the first conductive member;

FIG. 7 is another exploded view of the first conductive member; and

FIG. 8 is a sectional view of the floating connector terminal in a usage scenario.

### Description of Reference Numerals:

1-Carrying member; 11-First receiving groove; 12-First through hole;

2-Floating member; 21-Connecting body; 211-Second through hole; 22-Movable body;

3-First conductive member; 30-Second receiving groove; 31-Support ring; 32-First elastic piece; 321-First arc surface; 322-Second arc surface; 33-Second elastic piece; 331-Third arc surface; 332-Fourth arc surface;

4-Second conductive member;

5-Fixing member.

### DETAILED DESCRIPTION

The following will disclose a plurality of embodiments of the present disclosure with reference to the drawings. For the sake of clear description, many practical details will be described together in the following description. However, it should be understood that these practical details should not be used to limit the present disclosure. That is to say, in some embodiments of the present disclosure, these practical details are not necessary. In addition, for the purpose of simplifying the drawings, some well-known and commonly used structures and assemblies will be illustrated in a simple and schematic manner in the drawings.

In addition, descriptions such as “first,” “second”, or the like in the present disclosure are merely for descriptive purposes, and do not particularly refer to an order or sequence, nor are they used to limit the present disclosure. They are merely used to distinguish assemblies or operations described with the same technical terms, and cannot be construed as indicating or implying their relative importance or implicitly indicating the number of the indicated technical features. Thus, a feature defined as “first” or “second” may explicitly or implicitly include at least one such feature. In addition, the technical solutions between various examples can be combined with each other, but must be on the basis that they can be implemented by a person of ordinary skill in the art. When a combination of technical solutions is contradictory or cannot be implemented, it should be considered that such a combination of technical solutions does not exist and is not within the protection scope claimed by the present disclosure.

### Example I

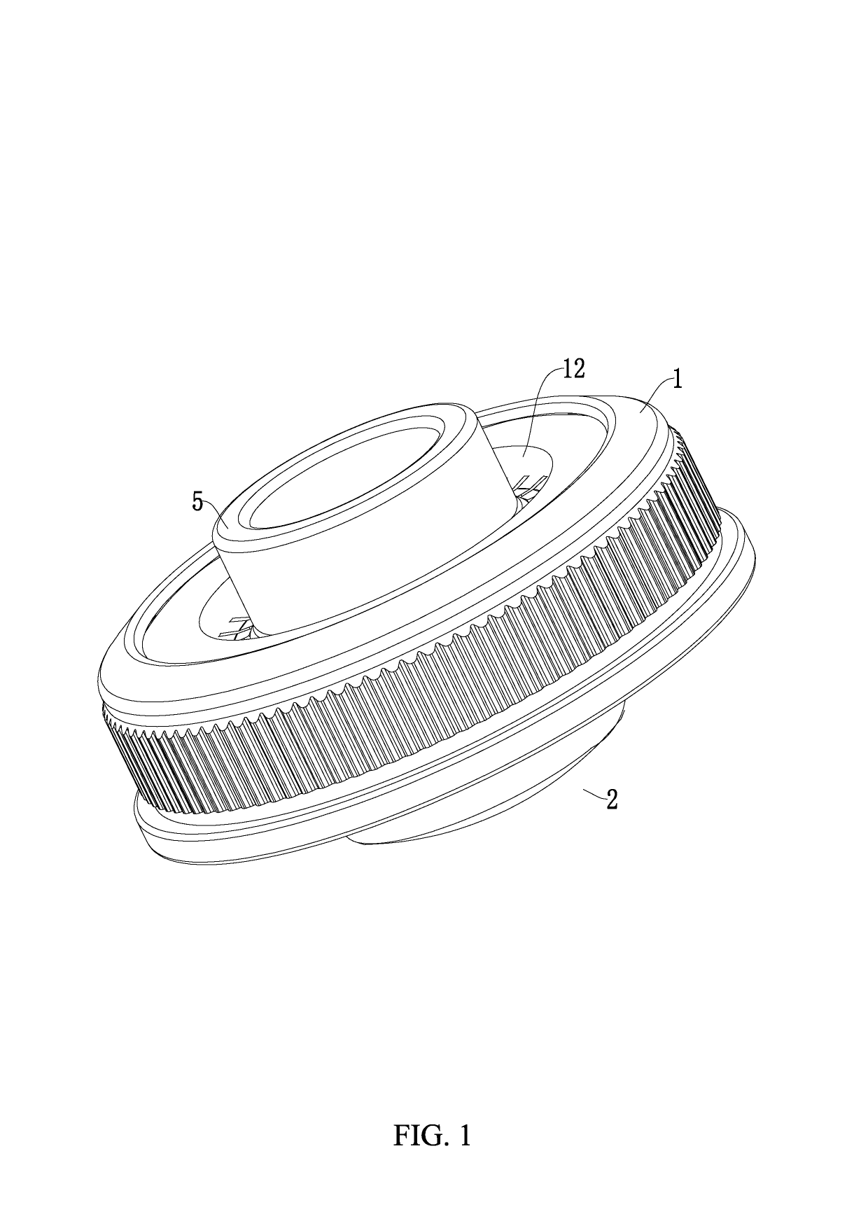

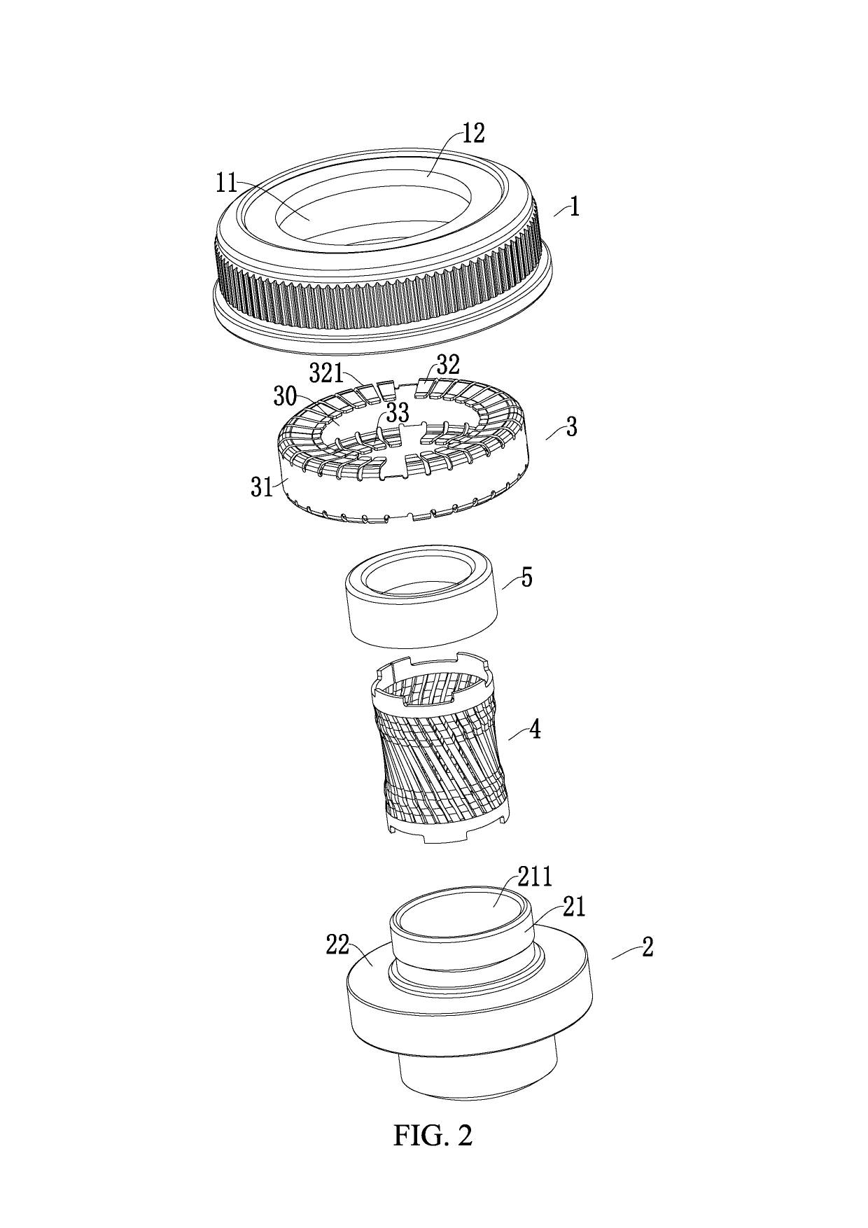

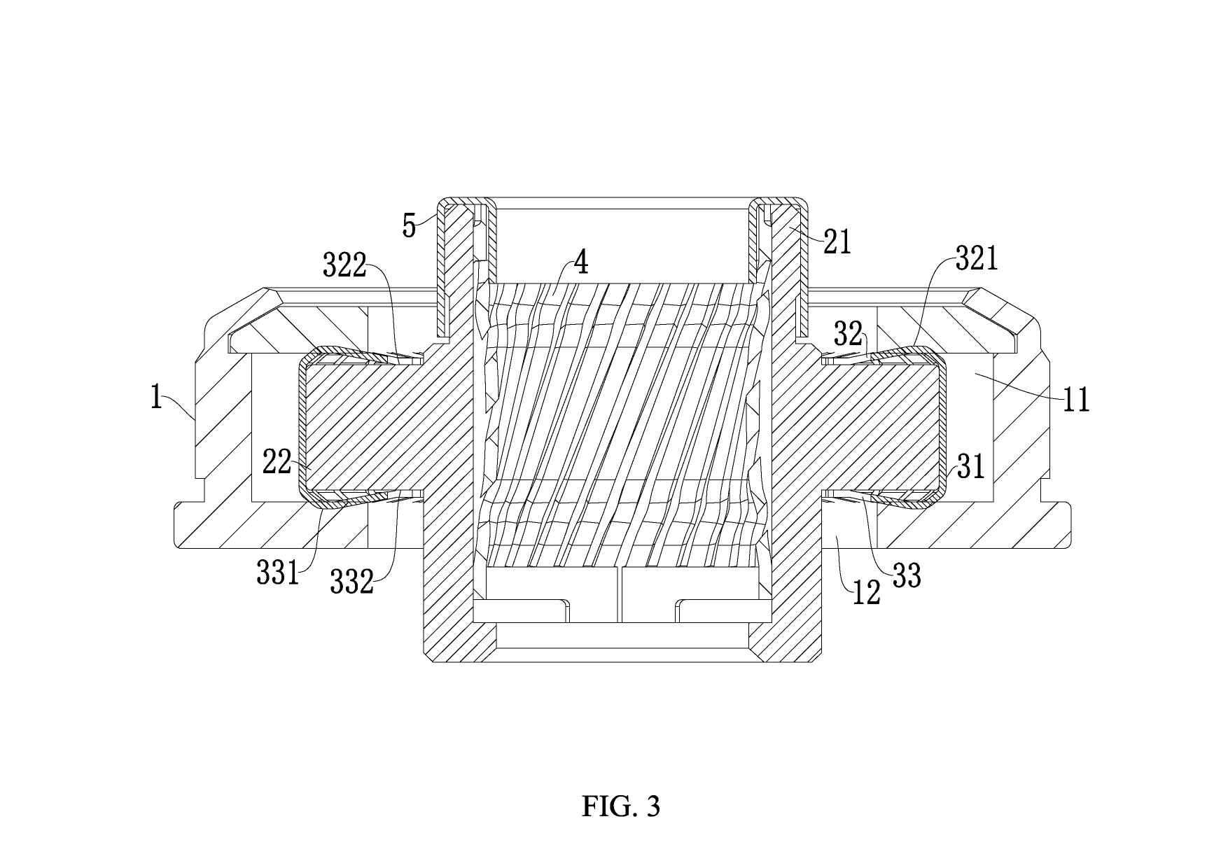

As shown in FIGS. 1 to 3, FIG. 1 is a schematic perspective structural view of a floating connector terminal; FIG. 2 is an exploded view of the floating connector terminal; and FIG. 3 is a schematic sectional view of the floating connector terminal. The floating connector terminal includes a carrying member 1, a floating member 2, and a first conductive member 3. The first conductive member 3 is disposed between the carrying member 1 and the floating member 2. The floating member 2 can drive the first conductive member 3 to move relative to the carrying member 1.

The carrying member 1 has a first receiving groove 11. The first conductive member 3 is located within the first receiving groove 11. The floating member 2 can drive the first conductive member 3 to move within the first receiving groove 11 to achieve position adjustment.

The carrying member 1 further has a first through hole 12. The first through hole 12 is formed along an axial direction, and the first through hole 12 is in communication with the first receiving groove 11. The floating member 2 has a connecting body 21 and a movable body 22. The connecting body 21 extends through the first through hole 12, and the connecting body 21 is movable within the first through hole 12. The movable body 22 is disposed on an outer periphery of the connecting body 21. The first conductive member 3 is disposed on an outer surface of the movable body 22. The movable body 22 can drive the first conductive member 3 to move within the first receiving groove 11. It should be noted that the connecting body 21 and the movable body 22 may be an integral structure.

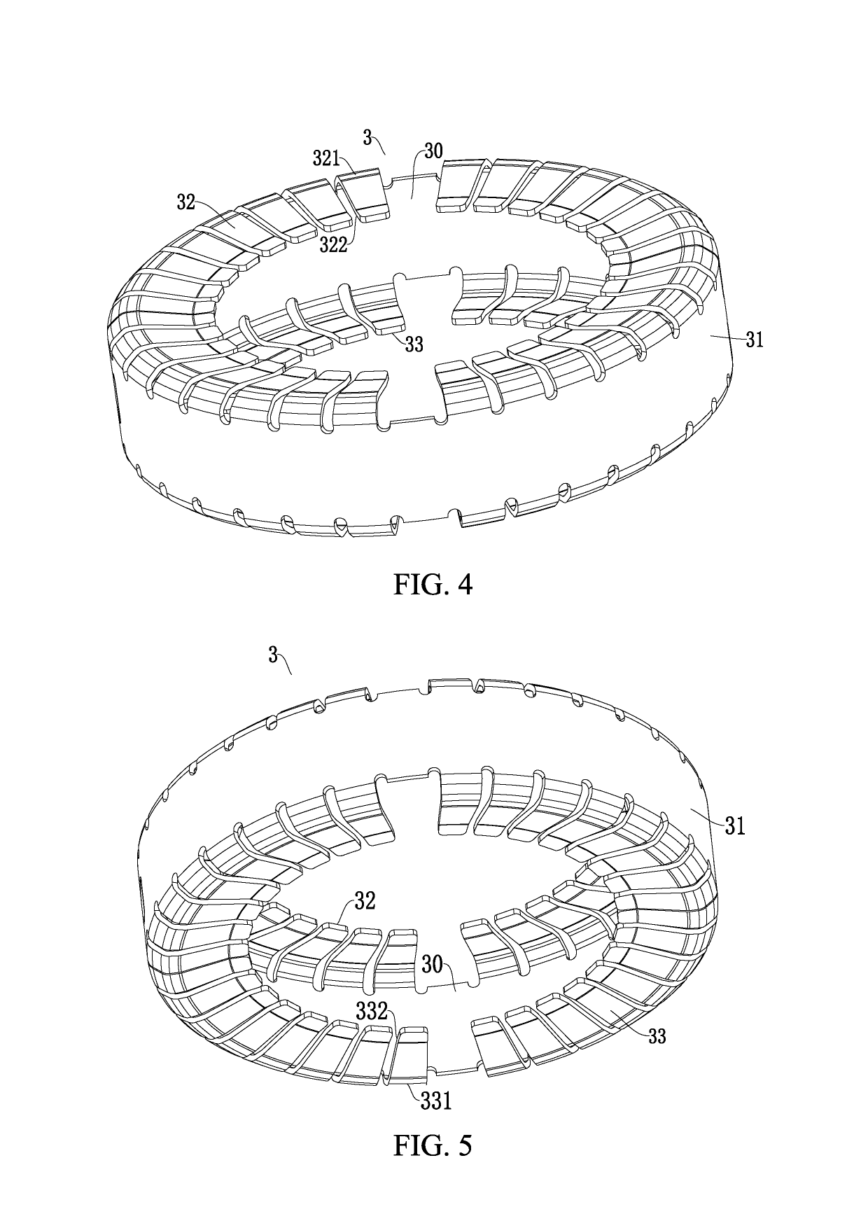

Referring also to FIGS. 4 and 5, FIG. 4 is a schematic perspective structural view of the first conductive member 3; and FIG. 5 is another schematic perspective structural view of the first conductive member 3. The first conductive member 3 includes a support ring 31, a plurality of first elastic pieces 32, and a plurality of second elastic pieces 33. The plurality of first elastic pieces 32 are arranged spaced apart at one end of the support ring 31, and are distributed along a periphery of an end portion of the support ring 31. The plurality of first elastic pieces 32 all extend toward an inner direction of the support ring 31. The plurality of second elastic pieces 33 are arranged spaced apart at the other end of the support ring 31, and are distributed along a periphery of an end portion of the support ring 31. The plurality of second elastic pieces 33 all extend toward the inner direction of the support ring 31. The plurality of first elastic pieces 32 abut against one side wall of the first receiving groove 11 and one side of the outer surface of the movable body 22, and the plurality of second elastic pieces 33 abut against another opposite side wall of the first receiving groove 11 and another side of the outer surface of the movable body 22. Specifically, the support ring 31, the plurality of first elastic pieces 32, and the plurality of second elastic pieces 33 jointly form a second receiving groove 30. The movable body 22 is located within the second receiving groove 30. The support ring 31, the plurality of first elastic pieces 32, and the plurality of second elastic pieces 33 all abut against the outer surface of the movable body 22. In a specific application, a shape of the second receiving groove 30 is adapted to a shape of the movable body 22, so as to facilitate assembly of the second receiving groove 30 and the movable body 22. Meanwhile, the first conductive member 3 forms an enclosure wrapping around the movable body 22, thereby enhancing stability of connection therebetween and increasing a contact area therebetween.

The first elastic piece 32 has a first arc surface 321. The first arc surface 321 is disposed at one end portion of the first elastic piece 32 that is closer to the support ring 31, and the first arc surface 321 abuts against one side wall of the first receiving groove 11. Further, the first elastic piece 32 further has a second arc surface 322. The second arc surface 322 is disposed at one end portion of the first elastic piece 32 that is away from the support ring 31, and a protruding direction of the second arc surface 322 is opposite to a protruding direction of the first arc surface 321. The second arc surface 322 abuts against the outer surface of the movable body 22.

The second elastic piece 33 has a third arc surface 331. The third arc surface 331 is disposed at one end portion of the second elastic piece 33 that is closer to the support ring 31, and the third arc surface 331 abuts against another opposite side wall of the first receiving groove 11. Further, the second elastic piece 33 further has a fourth arc surface 332. The fourth arc surface 332 is disposed at one end portion of the second elastic piece 33 that is away from the support ring 31, and a protruding direction of the fourth arc surface 332 is opposite to a protruding direction of the third arc surface 331. The fourth arc surface 332 abuts against the outer surface of the movable body 22.

In a specific application, the first elastic piece 32 may have a plurality of first arc surfaces 321, and a plurality of second arc surfaces 322. Similarly, the second elastic piece 33 may also have a plurality of third arc surfaces 331, and a plurality of fourth arc surfaces 332.

In this example, the first conductive member 3 is an integral structure. When in use, the first conductive member 3 can be expanded such that an inner diameter thereof is greater than an outer diameter of the movable body 22. After the first conductive member 3 is moved to a respective position, an external force is removed such that the first conductive member 3 is retracted, and finally the first conductive member 3 is sleeved on the outer surface of the movable body 22. In addition, another assembly manner may also be adopted. For example, in an initial state, the first conductive member 3 is in a flattened state, and then the first conductive member 3 is directly fitted along the outer periphery of the movable body 22. After assembling in such assembly manner, a gap will exist in the support ring 31, and disassembly can be performed later through this gap. Certainly, closing processing may also be finally performed on the support ring 31 to eliminate this gap.

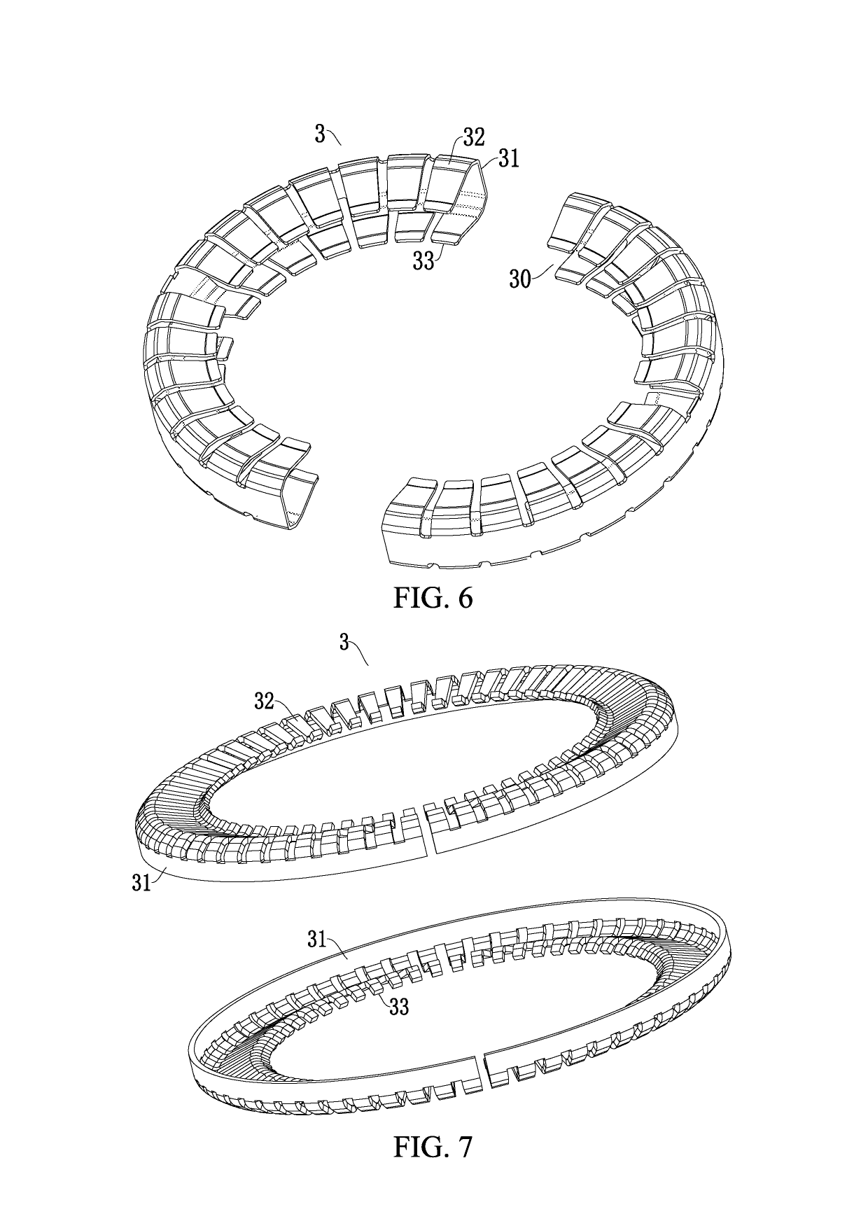

As shown in FIG. 6, FIG. 6 is an exploded view of the first conductive member 3. In another example, the first conductive member 3 may be cut along the axial direction, such that the first conductive member 3 is divided into two parts. When assembling, it is only necessary to sleeve the two parts on the outer surface of the movable body 22. In order to facilitate installation and disassembly, the two parts may be connected by providing a structure of a locking block and a locking groove.

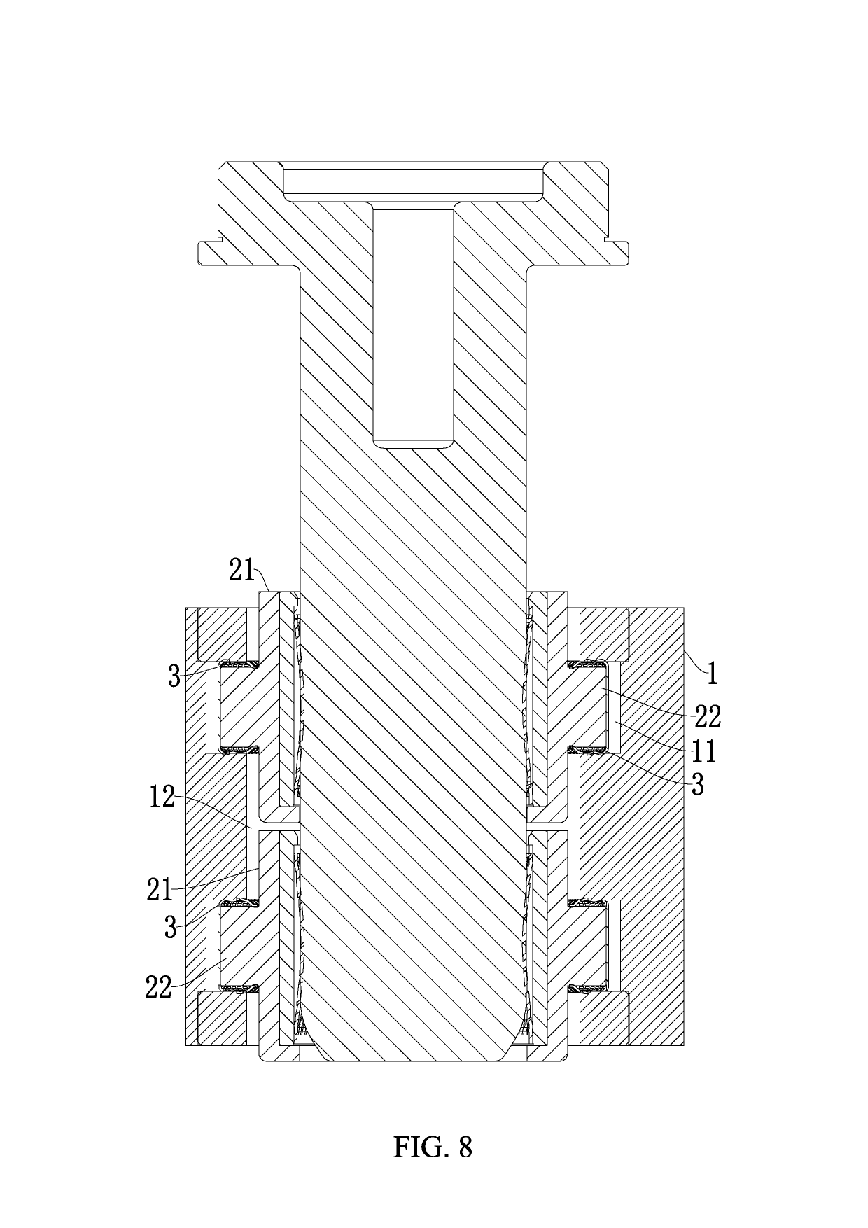

As shown in FIG. 7, FIG. 7 is another exploded view of the first conductive member 3. In another example, the first conductive member 3 may be cut along a radial direction, such that the first conductive member 3 is divided into two parts. When assembling, it is only necessary to sleeve the two parts on the outer surface of the movable body 22. In order to facilitate installation and disassembly, the two parts may be connected by providing a structure of a locking block and a locking groove.

Please refer to FIGS. 2 and 3 again, the floating connector terminal further includes a second conductive member 4. The connecting body 21 is provided with a second through hole 211 formed along an axial direction thereof. The second conductive member 4 is disposed within the second through hole 211. An external plug pin is inserted into the second conductive member 4 and pushes the second conductive member 4 to expand outward, such that the contact area between the second conductive member 4 and an inner wall of the second through hole 211 is larger, to improve current conduction performance. Furthermore, the floating connector terminal further includes a fixing member 5. The fixing member 5 is sleeved on one end of the connecting body 21. Meanwhile, a snap-fit connection is formed among the fixing member 5, one end portion of the connecting body 21, and one end portion of the second conductive member 4, to enhance a connection effect between the second conductive member 4 and the connecting body 21.

In this example, both the first conductive member 3 and the second conductive member 4 are made of a material with high electrical conductivity and high yield strength.

In summary, the second receiving groove 30 of the first conductive member 3 wraps around the floating member 2, which increases the contact area between the first conductive member 3 and the floating member 2. When in use, a larger current can flow between the carrying member 1 and the floating member 2, thereby improving the current-carrying capacity and charging efficiency thereof.

### Example II

As shown in FIG. 8, FIG. 8 is a sectional view of the floating connector terminal in a usage scenario. The difference between this example and Example I is: the structure of the carrying member 1 is changed, but its function is similar. The carrying member 1 in this example is changed according to the usage scenario; in addition, two first receiving grooves 11 are provided within the carrying member 1. Correspondingly, two floating members 2, two first conductive members 3, and two second conductive members 4 are provided. One floating member 2, one first conductive member 3, and one second conductive member 4 form one group, and one group corresponds to one first receiving groove 11. Besides, this example also lacks the fixing member 5 compared to Example I.

What described above are merely embodiments of the present disclosure, and are not used to limit the present disclosure. For a person skilled in the art, the present disclosure may have various modifications and changes. Any modifications, equivalent replacements, improvements, or the like made within the spirit and principle of the present disclosure should be included within the scope of the claims of the present disclosure.

What is claimed is:

1. A floating connector terminal, comprising: a carrying member, a floating member, and a first conductive member, the carrying member having a first receiving groove, the first conductive member having a second receiving groove, the first conductive member being located within the first receiving groove, the floating member being located within the second receiving groove, the first conductive member abutting against both the carrying member and the floating member; wherein the floating member is capable of driving the first conductive member to move together within the first receiving groove.

2. The floating connector terminal according to claim 1, wherein the first conductive member comprises a support ring, a plurality of first elastic pieces, and a plurality of second elastic pieces, the plurality of first elastic pieces being spaced apart along one end of the support ring, the plurality of second elastic pieces being spaced apart along the other end of the support ring, the support ring, the plurality of first elastic pieces, and the plurality of second elastic pieces jointly forming the second receiving groove, the support ring, the plurality of first elastic pieces, and the plurality of second elastic pieces all abutting against the floating member, the plurality of first elastic pieces and the plurality of second elastic pieces further abutting against side walls of the first receiving groove.

3. The floating connector terminal according to claim 2, wherein one end portion of the first elastic piece that is closer to the support ring is provided with a first arc surface, the first arc surface abutting against the side wall of the first receiving groove.

4. The floating connector terminal according to claim 3, wherein one end portion of the first elastic piece that is away from the support ring is provided with a second arc surface, the second arc surface and the first arc surface facing in opposite directions, and the second arc surface abutting against the floating member.

5. The floating connector terminal according to claim 2, wherein an end portion of the second elastic piece that is closer to the support ring is provided with a third arc surface, the third arc surface abutting against the side wall of the first receiving groove.

6. The floating connector terminal according to claim 5, wherein one end portion of the second elastic piece that is away from the support ring is provided with a fourth arc surface, the fourth arc surface and the third arc surface facing in opposite directions, and the fourth arc surface abutting against the floating member.

7. The floating connector terminal according to claim 1, wherein the first conductive member is of an integral structure, or a split structure divided along an axial direction, or a split structure divided along a radial direction.

8. The floating connector terminal according to claim 1, wherein the floating member comprises a connecting body and a movable body, the connecting body being movably disposed within a first through hole of the carrying member, the movable body being disposed on an outer periphery of the connecting body, and the movable body being located within the second receiving groove, and the movable body driving the first conductive member to move together within the first receiving groove.

9. The floating connector terminal according to claim 8, further comprising a second conductive member, wherein the connecting body is provided with a second through hole formed along an axial direction, the second conductive member being disposed within the second through hole.

10. The floating connector terminal according to claim 9, further comprising a fixing member located at one end of the connecting body, wherein the fixing member is snap-fit connected with the second conductive member and the connecting body.
